(19) United States
(12) Patent Application Publication
(10) Pub. No.: US 2010/0031252 A1
(43) Pub. Date: Feb. 4, 2010

(54) Method And System For Monitoring The Performance Of An Application And At Least One Storage Device For Storing Code Which Performs The Method

(75) Inventor: Michael A. Horwitz, Berkley, MI (US)

Correspondence Address: BROOKS KUSHMAN P.C., 1000 TOWN CENTER, TWENTY-SECOND FLOOR, SOUTHFIELD, MI, 48075, US

(73) Assignee: Compuware Corporation, Detroit, MI (US)

(21) Appl. No.: 12/181,478

(22) Filed: Jul. 29, 2008

(51) Int. Cl. G06F 9/455

(52) U.S. Cl. 718/1

(57) ABSTRACT

A method and system of monitoring the performance of an application running across multiple virtual machines using thread instance data are provided. The application runs or executes in an environment in which a first thread is processed on a first virtual machine in response to an invocation process and a second thread is processed on a second virtual machine in response to a request to invoke from the first thread. The method includes automatically generating first and second sets of thread instance data. The first set of thread instance data is based on the processing of the first thread and the second set of thread instance data is based on the processing of the second thread. The method also includes correlating the first and second sets of thread instance data to tie the invocation and performance of the processing of the first thread to the performance of the processing of the second thread. The invocation process is followed across the threads of execution of the multiple virtual machines.

### BACKGROUND OF THE INVENTION

1. Field of the Invention

This invention relates to methods and systems for monitoring the performance of an application and at least one storage device for storing code which performs the method. The invention has particular utility in the field of performance analysis of Java and .NET applications that invoke remote methods in a different virtual machine. This includes remote methods on the same physical computer as well as remote methods on a different physical computer. It also includes a sequence of virtual (and possibly remote) machines where machine A calls machine B which calls machine C.

2. Background Art

Modem Web applications typically invoke remote methods (or transactions) on a back-end Java or .NET virtual machine that is different than the Web application's virtual machine. This back-end virtual machine can be running an Enterprise Java Beans (EJB) server, or any generic Java application. Since the servers are on different virtual machines, there is typically no way to tie the performance of a unique Web transaction (pertaining to one specific request by a user) to the performance of the related unique back-end transaction.

The Open Group Application Response Measurement (ARM) has been developed to do something similar, but it has no facility to actually tie the two unique transactions together. Furthermore, it is up to the individual programmer to change the production application code to take advantage of the ARM API as described in U.S. Pat. No. 6,144,961. More information on ARM can be found at http://en.wikipedia.org/wiki/Application_Response_Measurement.

Published U.S. Patent Application 2007/0143323 to Vanrenen et al. discloses the correlation of data relating to execution flows running on different processes or threads at a computer system. The execution flows may represent sequences of software components that are invoked or other computer system resources that are consumed. A first execution flow fulfills a first request by transmitting a second request which initiates a second execution flow, such as at another computer system. The second request includes meta data, which identifies a context of the first request, such as a URL, an agent which monitors the first execution flow which initiated the second request. A manager receives information regarding the first execution flow from the first agent, and information regarding the second execution flow, along with the meta data, from a second agent, for correlating the first and second execution flows. The received information may include execution flow shape data.

As described by Vanrenen et al., an execution flow can be traced to identify each component that is invoked as well as obtain performance data such as the execution time of each component. An execution flow refers generally to the sequence of steps taken when a computer program executes. Tracing refers to obtaining a detailed record, or trace, of the steps a computer program executes. One type of trace is a stack trace. Traces can be used as an aid in debugging. However, information cannot be obtained and analyzed from every execution flow without maintaining an excessive amount of overhead data and thereby impacting the very application which is being monitored. One way to address this problem is by sampling so that information is obtained regarding every nth execution flow. This approach is problematic because it omits a significant amount of data and, if a particular execution flow instance is not selected for sampling, all information about it is lost. Thus, if a particular component is executing unusually slowly, for instance, but only on an irregular basis, this information may not be captured.

As further described by Vanrenen et al., another approach, aggregation, involves combining information from all execution flows into a small enough data set that can be reported. For example, assume there are one thousand requests to an application server. For each execution flow, performance data such as the response time can be determined. Information such as the slowest, fastest, median and mean response times can then be determined for the aggregated execution flows. However, aggregating more detailed information about the execution flows is more problematic since the details of the execution flows can differ in various ways. Vanrenen et al. deal with aggregating information between related execution flows, such as at different computer systems.

### SUMMARY OF THE INVENTION

An object of the present invention is to provide an improved method and system for monitoring the performance of an application and at least one storage device for storing code which performs the method and which do not require the user to make any modifications to their program. Automated tracking and reporting of program execution across multiple virtual machines is provided.

In addition, the sequence of local and remote methods may be displayed in a single, hierarchical display that allows for the easy understanding and resolution of application performance problems.

In carrying out the above object and other objects of the present invention, a method of monitoring the performance of an application running in an environment in which a first thread is processed on a first virtual machine in response to an invocation process and a second thread is processed on a second virtual machine in response to a request to invoke from the first thread is provided. The method includes automatically generating first and second sets of thread instance data. The first set of thread instance data is based on the processing of the first thread and the second set of thread instance data is based on the processing of the second thread. The method further includes correlating the first and second sets of thread instance data to tie the invocation and performance of the processing of the first thread to the performance of the processing of the second thread. The invocation process is followed across the threads of execution of multiple virtual machines.

Each of the threads may have a stack. The first set of instance data may represent the location of the stack of the first thread and a representation of the current thread context executing on the first virtual machine and the second set of thread instance data may represent the location of the stack of the second thread and a representation of thread context of the second virtual machine. The step of correlating may correlate the thread and stack locations on both machines.

The method may further include transmitting data from the first virtual machine to the second virtual machine. The transmitted data may include the first set of thread instance data.

The method may further include the step of transmitting the first and second sets of thread instance data to a nucleus server. The nucleus server may perform the step of correlating.

The application may be a real application.

The environment may be a production environment.

The method may be computer-implemented.

The environment may be a distributed computer environment.

Further in carrying out the above object and other objects of the present invention, an apparatus for monitoring the performance of the application running in an environment in which a first thread is processed on a first virtual machine in response to an invocation process and a second thread is processed on a second virtual machine in response to a request to invoke from the first thread is provided. The apparatus includes at least one storage device and at least one processor in communication with the at least one storage device. The at least one processor performs a method which includes generating first and second sets of thread instance data. The first set of thread instance data is based on the processing of the first thread and the second set of thread instance data is based on the processing of the second thread. The method performed by the processor further includes correlating the first and second sets of thread instance data to tie the invocation and performance of the processing of the first thread to the performance of the processing of the second thread. The invocation process is followed across the threads of execution of multiple virtual machines.

Still further in carrying out the above object and other objects of the present invention, at least one processor-readable storage medium having processor-readable code embodied thereon for programming at least one processor to perform a method for monitoring the performance of an application running in an environment in which a first thread is processed on a first virtual machine in response to an invocation process and a second thread is processed on a second virtual machine in response to a request to invoke from the first thread is provided. The method includes generating first and second sets of thread instance data. The first set of thread instance data is based on the processing of the first thread and the second set of thread instance data is based on a processing of the second thread. The method further includes correlating the first and second sets of thread instance data to tie the invocation and performance of the processing of the first thread to the performance of the processing of the second thread. The invocation process is followed across the threads of execution of multiple virtual machines.

The above object and other objects, features, and advantages of the present invention are readily apparent from the following detailed description of the best mode for carrying out the invention when taken in connection with the accompanying drawings.

### BRIEF DESCRIPTION OF THE DRAWINGS

FIG. 1 is a block diagram schematic view of a distributed computer network or environment in which different virtual machines provide sets of thread instance data to a nucleus server which correlates the sets of data;

FIG. 2 is a screenshot at a user interface wherein at least one embodiment of the present invention is used;

FIG. 3 is a screenshot at a user interface wherein at least one embodiment of the present invention is used;

FIG. 4 is a screenshot at a user interface wherein at least one embodiment of the present invention is used;

FIG. 5 is a screenshot at a user interface wherein at least one embodiment of the present invention is used;

FIG. 6 is a screenshot at a user interface wherein the present invention is not used;

FIG. 7 is a screenshot at a user interface wherein the present invention is not used; and

FIG. 8 is a screenshot at a user interface wherein the present invention is not used.

### DETAILED DESCRIPTION OF THE PREFERRED EMBODIMENT(S)

Each virtual machine in a distributed computer environment is made up of threads of execution. These threads are independent of each other while executing, but can be started, stopped, and called by other threads. Distributed computing allows for the threads of one virtual machine to invoke threads on another virtual machine. These are referred to as “remote procedure calls” or “remote process calls.”

Some operating systems and platforms utilize a technique called “thread pooling.” This technique creates a pre-defined number of threads, and reuses them for various executions that the system requires.

In at least one embodiment of the invention, a technique is provided to identify each unique usage of a thread within a thread pool. A request identifier is assigned and incremented for each unique usage of the thread. The combination of the thread identifier and request identifier is used to uniquely identify a “transaction” or what will subsequently be referred to as a “thread instance.”

Each thread is comprised of program code that is executing. The threads contain a call stack. The call stack represents the currently executing piece of code. It is commonly referred to simply as “the stack.”

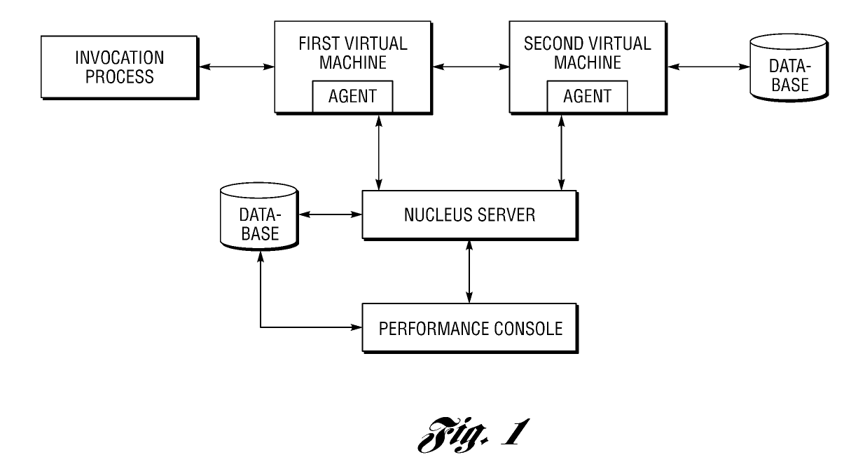

Referring now to FIG. 1, when a thread on one virtual machine remote invokes a thread on a second virtual machine, the underlying operating system, or platform, handles the stacks and threads of each machine. This is done differently for different platforms and operating systems. When the second virtual machine's thread ends, it knows the exact thread and stack location of the first virtual machine to return to. In a distributed computer system, this remote invocation happens via communications between the two machines. This communication is referred to as “the wire.”

In at least one embodiment of the present invention, a unique correlation identifier for the first machine's remote invocation of the second machine's thread is provided. This identifier represents the exact location in the first machine's stack, and the exact representation of the current thread context executing on that machine. This identifier is sent to the second machine, automatically appended to the first machine's operating system or platform level request to invoke the remote thread on the second machine. This is the data appended onto the wire. There is no user intervention required. The identifier and its definition are also sent to the nucleus server at this time. When the second machine's thread starts, it sends its exact stack location to the nucleus server. When the second machine's transaction finishes, it sends that same identifier (passed from the first machine on the wire) back to the nucleus server, along with its exact thread context, allowing the nucleus server to directly correlate the two exact stack and thread locations on both machines.

As noted above, at least one embodiment of the present invention focuses on the specific correlation of the individual thread instances. In other words, data is used specific to an individual transaction rather than data about the type of transaction which is then aggregated. Advantageously, this technique can be used to follow a specific instance of a request across multiple virtual machines' threads of execution. This allows for the diagnosis of a problem that may only happen once while thousands of similar requests with the same user-facing data have been made. This would be impossible to recognize with the aggregation technique employed by the prior art. This technique has solved the overhead issue mentioned in the prior art.

The technique of at least one embodiment of the present invention applies at the lower level of machine threads and call stacks, allowing for the specific instance correlation mentioned above.

Furthermore, unlike the prior art, the at least one embodiment does not require a Web browser or any user-facing data to accomplish the correlation. Advantageously, the present technique can be used in any environment that utilizes virtual machines, be it Web, command-line, or any other type of invocation process that starts the first virtual machine threads.

Unlike the prior art, the at least one embodiment does not require any user intervention. The correlation is done automatically. The present technique can be used in a production environment where user intervention is not allowed, or closely controlled. This allows the users to monitor the real application, rather than a debug or test version of it.

The at least one embodiment does not require any debug clients. Advantageously, this technique can be used in a product environment where debug clients are not allowed. Again, this allows the users to monitor the real application, rather than a debug or test version of it.

As previously noted, instance data is sent from one specific execution of a thread to another specific execution of a thread. This instance data specifically ties the two thread instances together, rather than correlating two generic flows. Specific instance data is received and correlated for individual threads, not an aggregated set of data related to an execution flow. This allows for the direct correlation of the first virtual machine's thread's performance to the second virtual machine's thread's performance. It is to be understood, however, that one embodiment of the invention may be utilized to correlate specific thread instances for inter-process communication within one virtual machine.

When used in a Java or .NET environment, at least one embodiment of the invention can instrument (change on the fly) the underlying Java and .NET system code. This allows one to alter the information that is transmitted across the network of FIG. 1 from one virtual machine to the other. This alteration in no way affects or impacts the actual transaction. The actual code of both the calling and the called application is unaltered. The data that is added to the transmission is the data that correlates the two remote thread instances and ties them together.

The calling machine puts the additional data on the wire with the program's original request to be sent to a program running on the second virtual machine (which may be on a separate computer). Instrumented code on the remote virtual machine pulls this additional data off and uses it to correlate the two transactions. Subsequently, the remote machine could invoke a method on another virtual machine, and the process would be exactly the same for the calls from it to this third machine.

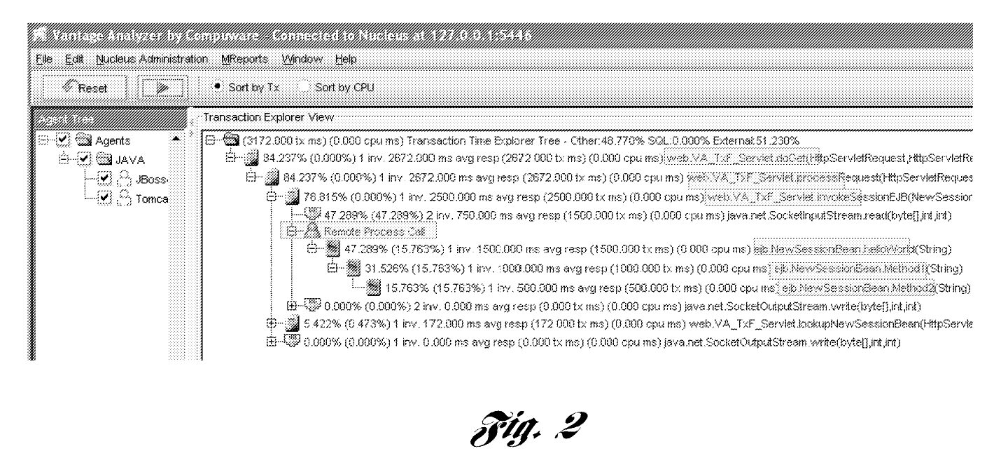

Once the additional data is captured at the remote virtual machine, it is sent to a common database of performance data so that it can be correlated with other local and remote transactions. A view or screenshot on the performance console of FIG. 1 is illustrated in FIG. 2 wherein at least one embodiment of the present invention is used in the environment of FIG. 1. Note the hierarchy of ‘web’ calls leading to the remote process call. At this point, it switches virtual machines to the ‘ejb’ machine and the ‘ejb’ call stack follows. It appears as just one transaction though, which in fact it is, across multiple virtual machines.

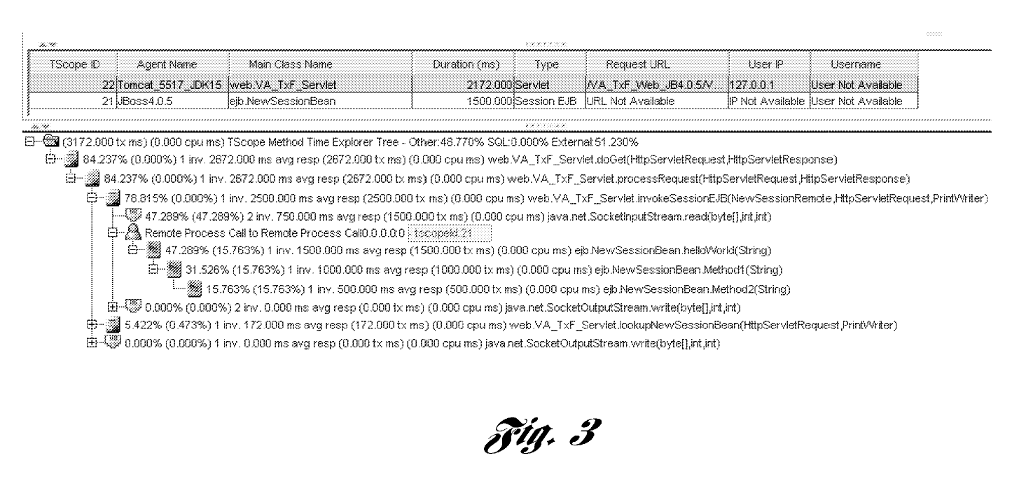

Referring now to FIG. 3, which is similar to FIG. 2, there is illustrated a transaction view wherein two thread instances are displayed (id-22 web VM, id=21 ejb VM). When the calling thread instance 22 is selected, the entire transaction flow is displayed, including the called thread instance 21, making it appear as the one single transaction that it is.

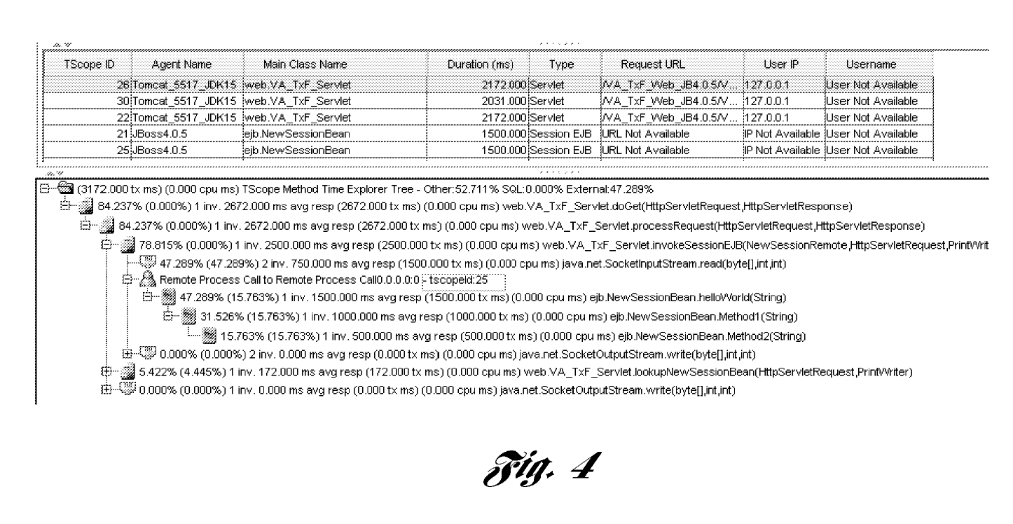

Referring now to FIG. 4, which is similar to FIGS. 2 and 3, there is illustrated a transaction view wherein multiple thread instances are displayed (id=22,26,30 web VM, id=21,25 ejb VM). This time, thread instance 26 is selected from the web machine. It is directly tied to thread instance 25 from the ejb machine. This is the exact same transaction as thread instance 22 (note the same class name, duration, and URL) as seen from the user perspective, but is broken down into the specific thread instances behind this specific invocation of it. There is no aggregation or flow shapes, just an exact match of specific thread instances and stacks.

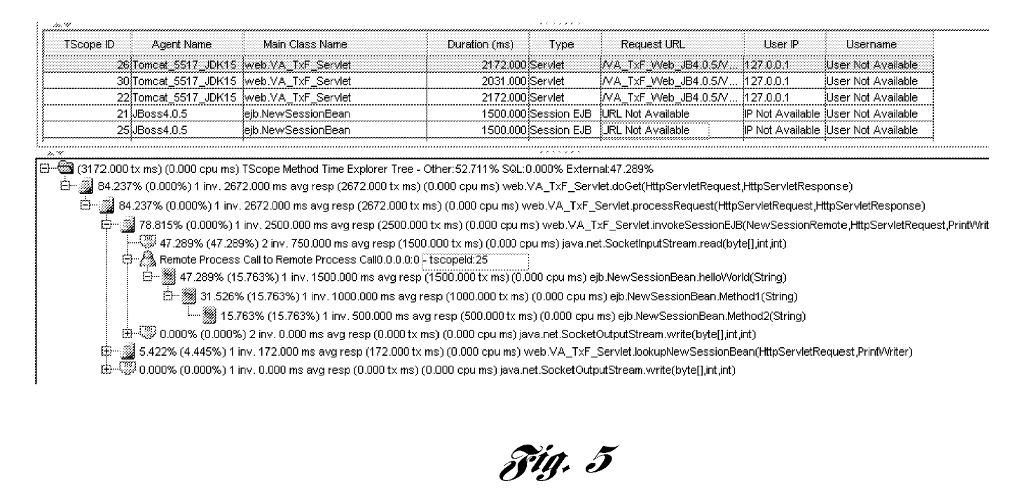

Referring now to FIG. 5, which is similar to FIGS. 2, 3 and 4, there is illustrated support for recognizing what URL an ejb method was handling. While the URL is not used to do the correlation, it does come in handy. For example, one now knows that thread instance 25 on the ‘ejb’ machine was invoked to handle a request from the /VA_TxF_Web_JB4.0.5/V URL from thread instance 26 on the ‘web’ machine.

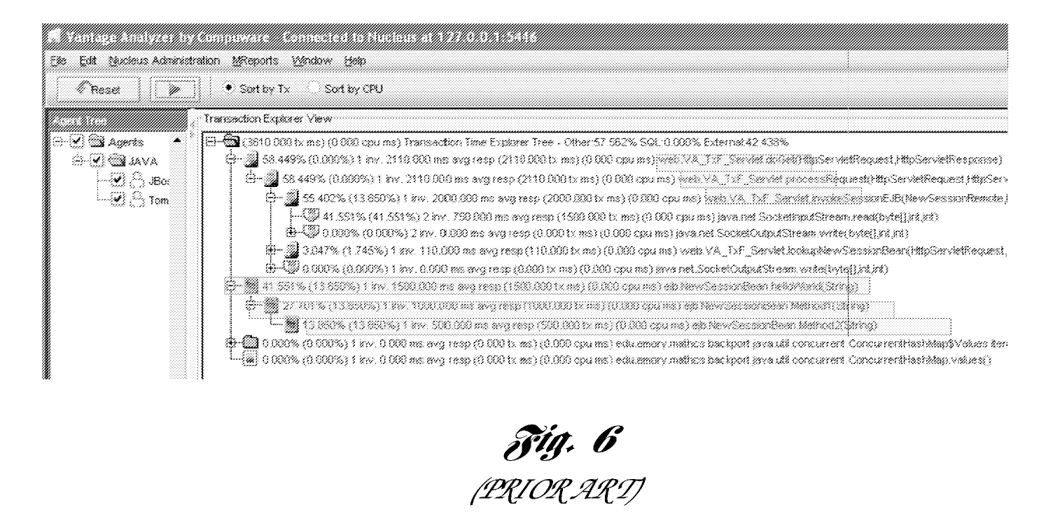

Referring now to FIG. 6, which is a screenshot resulting from a prior art method and system, note the hierarchy of ‘web’ calls leading to a generic socket call (no indication of a remote call). At this point, the call stack effectively ends. Note that the hierarchy of ‘ejb’ calls appears to begin at the top of the stack. There is no indication that it was invoked by the ‘web’ stack. It appears as two different transactions, with no correlation whatsoever.

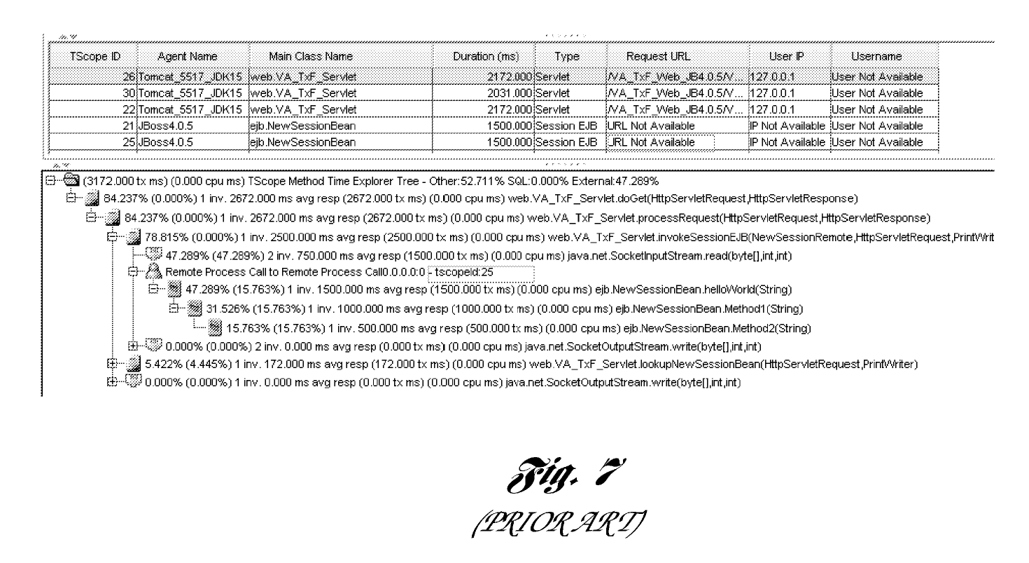

Referring now to FIG. 7, which is similar to FIG. 6, there is illustrated a transaction view wherein two thread instances are displayed (id=1 web VM, id=0 ejb VM). When the calling thread instance 1 is selected, only that thread instance is displayed. The called thread instance 0 is not correlated at all to the calling thread instance.

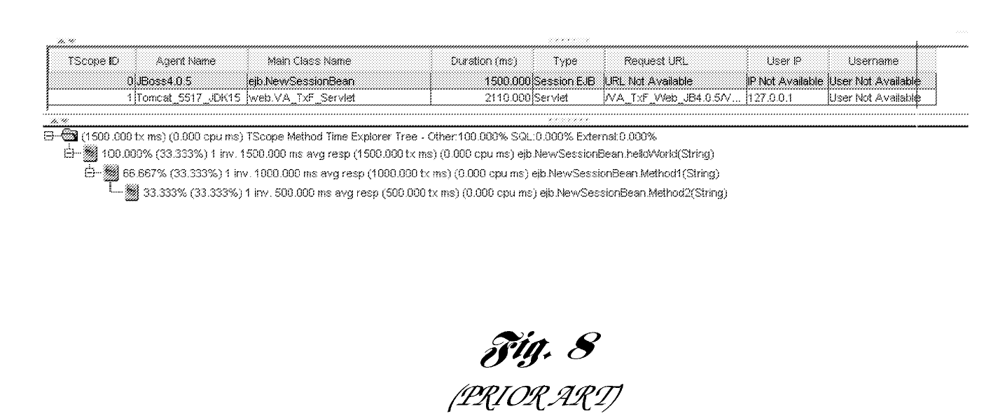

Referring now to FIG. 8, which is similar to FIGS. 6 and 7, there is illustrated a transaction view wherein two thread instances are displayed (id=1 web VM, id=0 ejb VM). When the called thread instance 0 is selected, there is no indication as to who invoked it. If there was a problem with the thread instance 1, the user does not know that it also invoked thread instance 0, which is where the actual problem may have been.

In a Web environment, by using at least one embodiment of the invention, the owners (developers, DBAs, operators, etc. . . . ) of a website can now track a user's transaction across multiple layers of their entire virtual machine infrastructure. This allows them to pinpoint performance bottlenecks in areas other than just the Web server, and ultimately enhances the overall performance of their website. This will lead to increased customer satisfaction.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of monitoring the performance of an application running in an environment in which a first thread is processed on a first virtual machine in response to an invocation process and a second thread is processed on a second virtual machine in response to a request to invoke from the first thread, the method comprising:
automatically generating first and second sets of thread instance data, the first set of thread instance data being based on the processing of the first thread and the second set of thread instance data being based on the processing of the second thread; and
correlating the first and second sets of thread instance data to tie the invocation and performance of the processing of the first thread to the performance of the processing of the second thread wherein the invocation process is followed across the threads of execution of multiple virtual machines.

2. The method as claimed in claim 1, wherein each of the threads has a stack, the first set of instance data representing location of the stack of the first thread and a representation of the current thread context executing on the first virtual machine and the second set of thread instance data representing location of the stack of the second thread and a representation of thread context of the second virtual machine and wherein the step of correlating correlates the thread and stack locations on both machines.

3. The method as claimed in claim 2 further comprising transmitting data from the first virtual machine to the second virtual machine wherein the transmitted data includes the first set of thread instance data.

4. The method as claimed in claim 3 further comprising the step of transmitting the first and second sets of thread instance data to a nucleus server wherein the nucleus server performs the step of correlating.

5. The method as claimed in claim 1, wherein the application is a real application.

6. The method as claimed in claim 1, wherein the environment is a production environment.

7. The method as claimed in claim 1, wherein the method is computer-implemented.

8. The method as claimed in claim 1, wherein the environment is a distributed computer environment.

9. An apparatus for monitoring the performance of the application running in an environment in which a first thread is processed on a first virtual machine in response to an invocation process and a second thread is processed on a second virtual machine in response to a request to invoke from the first thread, the apparatus comprising:
at least one storage device; and
at least one processor in communication with the at least one storage device, the at least one processor performing a method comprising:
generating first and second sets of thread instance data, the first set of thread instance data being based on the processing of the first thread and the second set of thread instance data being based on the processing of the second thread; and
correlating the first and second sets of thread instance data to tie the invocation and performance of the processing of the first thread to the performance of the processing of the second thread wherein the invocation process is followed across the threads of execution of multiple virtual machines.

10. The apparatus as claimed in claim 9, wherein each of the threads has a stack, the first set of instance data representing location of the stack of the first thread and a representation of the current thread context executing on the first virtual machine and the second set of thread instance data representing location of the stack of the second thread and a representation of thread context of the second virtual machine and wherein the step of correlating correlates the thread and stack locations on both machines.

11. The apparatus as claimed in claim 10, wherein the method further comprises transmitting data from the first virtual machine to the second virtual machine wherein the transmitted data includes the first set of thread instance data.

12. The apparatus as claimed in claim 11, wherein the method further comprises the step of transmitting the first and second sets of thread instance data to a nucleus server wherein the nucleus server performs the step of correlating.

13. The apparatus as claimed in claim 9, wherein the application is a real application.

14. The apparatus as claimed in claim 9, wherein the environment is a production environment.

15. The apparatus as claimed in claim 9, wherein the environment is a distributed computer environment.

16. At least one processor-readable storage medium having processor-readable code embodied thereon for programming at least one processor to perform a method for monitoring the performance of an application running in an environment in which a first thread is processed on a first virtual machine in response to an invocation process and a second thread is processed on a second virtual machine in response to a request to invoke from the first thread, the method comprising:
generating first and second sets of thread instance data, the first set of thread instance data being based on the processing of the first thread and the second set of thread instance data being based on a processing of the second thread; and
correlating the first and second sets of thread instance data to tie the invocation and performance of the processing of the first thread to the performance of the processing of the second thread wherein the invocation process is followed across the threads of execution of multiple virtual machines.

17. The storage medium as claimed in claim 16, wherein each of the threads has a stack, the first set of instance data representing location of the stack of the first thread and a representation of the current thread context executing on the first virtual machine and the second set of thread instance data representing location of the stack of the second thread and a representation of thread context of the second virtual machine and wherein the step of correlating correlates the thread and stack locations on both machines.

18. The storage medium as claimed in claim 17, wherein the method further comprises transmitting data from the first virtual machine to the second virtual machine wherein the transmitted data includes the first set of thread instance data.

19. The storage medium as claimed in claim 18, wherein the method further comprises the step of transmitting the first and second sets of thread instance data to a nucleus server wherein the nucleus server performs the step of correlating.

20. The storage medium as claimed in claim 16, wherein the application is a real application.

21. The storage medium as claimed in claim 16, wherein the environment is a production environment.

22. The storage medium as claimed in claim 16, wherein the environment is a distributed computer environment.
